(19) United States
(12) Patent Application Publication
(10) Pub. No.: US 2006/0068142 A1
(43) Pub. Date: Mar. 30, 2006

(54) Welding tape and related taping method

(76) Inventor: Michael Hacikyan, Amherst, NY (US)

Correspondence Address: Walter W. Duft, Suite 2, 8616 Main Street, Williamsville, NY, 14221, US

(21) Appl. No.: 10/950,963

(22) Filed: Sep. 27, 2004

(51) Int. Cl. B32B 33/00

(52) U.S. Cl. 428/40.1; 156/291; 428/195.1; 428/189

(57) ABSTRACT

An inert gas welding tape for retaining a purge gas around a weld zone that is situated at a junction between two structures to be welded together by inert gas welding. The welding tape includes a flexible substrate and a pattern of adhesive on one side of the substrate. The adhesive pattern defines an adhesive-free zone that is substantially free of adhesive and spans the weld zone when the tape is mounted on the structures to be welded, such that substantially no adhesive will be present in the weld zone. The adhesive regions of the adhesive pattern will only contact the structures in areas that are outside of the weld zone. At installation time, a length of the welding tape is selected and any adhesive backing thereon is removed. The welding tape is then positioned over the structures to be welded, preferably with the adhesive-free zone substantially centered over the junction that forms part of the weld zone. With the welding tape in this position, the adhesive regions of the welding tape are adhered to areas of each structure that are outside of the weld zone.

### BACKGROUND OF THE INVENTION

1. Field of the Invention

The present invention relates generally to inert gas welding. More particularly, the invention is directed to welding tape for retaining purge gas around a weld zone.

2. Description of Prior Art

By way of background, inert gas welding is a species of arc welding in which the molten weld pool is shielded from atmospheric contamination and oxidation by bathing it with an inert gas, such as Argon, or a mixture of Helium and Argon. Popular examples of inert gas welding include TIG (Tungsten Inert Gas) welding and MIG (Metal Inert Gas) welding.

When welding together pipes and other enclosed structures using inert gas welding, it is important to purge the interior of the pipe or structure in the vicinity of the weld zone to prevent corrosion and the formation of oxides on the interior side of the weld pool. Sealing devices such as purge dams, bladders, and other barriers are conventionally used for this purpose. For example, when butt-welding or socket-welding the ends of two pipe sections to form a consolidated pipe run, two barrier-type devices can be situated within the pipes, one in each pipe on either side of the pipe junction. A purge gas is then introduced into the area between the barriers to drive off the atmospheric contaminants and bathe the weld zone with the gas.

Purge gas can be delivered to the pipe interior in several ways. One common technique is to insert a needle injector through a small gap maintained between the pipe ends. Another technique is to introduce the purge gas from within the pipes. For example, one of the barrier devices may be constructed to dispense purge gas into the region surrounding the weld zone from a purge gas source that is in fluid communication with the barrier.

In order to ensure that the purge gas is retained in and around the weld zone within the pipes, and ambient air is excluded from this region, some form of sealing is required in order to close off any gaps or openings that may be present between the pipe ends. The conventional sealing technique is to temporarily adhere one or more strips of welding tape around the circumference of the pipe junction. Initially, the tape covers substantially all of the pipe junction, but is then gradually peeled back as welding proceeds.

Conventional welding tape typically comprises a thin, flexible substrate comprising stainless steel foil, aluminum foil, or other heat-resistant material that is coated on one side with halogen-free adhesive, or other suitable adhesive material. A backing strip covers the adhesive until the tape is ready to be applied. One of the problems associated with use of conventional welding tape is that some of the adhesive tends to remain on the pipe as the tape is peeled back. This adhesive residue can cause fouling when it is heated during welding, resulting in an inferior weld and/or unwanted contaminant formation on the inside of the pipe.

Accordingly, there is presently a need for improvement in the construction of welding tape used for inert gas welding. What is required in particular is a welding tape that does not cause fouling problems as a result of adhesive residue contaminating the weld zone.

### SUMMARY OF THE INVENTION

The foregoing problems are solved and an advance in the art is provided by a novel welding tape for use at a weld zone situated at a junction between two structures to be welded together. The welding tape includes a flexible substrate and a pattern of adhesive on one side of the substrate. The adhesive pattern defines an adhesive-free zone that is substantially free of adhesive and spans the weld zone when the tape is mounted on the structures to be welded, such that no substantially adhesive will be present in the weld zone. The adhesive regions of the adhesive pattern will only contact the structures in areas that are outside of the weld zone.

The invention further contemplates a welding tape installation method for mounting a strip of welding tape according to the invention on a pair of structures to be welded together by inert gas welding. According to this method, a length of the welding tape is selected and any adhesive backing thereon is removed. The welding tape is then positioned over the junction between the structures so that the adhesive-free zone spans the weld zone. With the welding tape in this position, the adhesive regions of the welding tape are adhered to areas of each structure that are outside of the weld zone.

In exemplary embodiments of the invention, the welding tape's adhesive pattern is configured such that the adhesive-free zone is longitudinally centered between a pair of laterally disposed adhesive regions. In an exemplary installation method, one adhesive region is adhered to one structure to be welded, such as a first pipe, and the other adhesive region is adhered to the other structure to be welded, such as a second pipe. The welding tape will be positioned so that the adhesive-free zone is substantially centered over the junction between the structures. A visual indication may be provided on the non-adhesive side of the welding tape to facilitate tape alignment.

### BRIEF DESCRIPTION OF THE DRAWINGS

The foregoing and other features and advantages of the invention will be apparent from the following more particular description of preferred embodiments of the invention, as illustrated in the accompanying Drawings in which:

FIG. 1 is a cross-sectional centerline view of a pipe junction to be welded, showing a pair of purge dams respectively mounted at the end of each pipe and a strip of inert gas welding tape constructed in accordance with the invention covering a junction between the pipes;

FIG. 2a is a plan view showing the adhesive side of a length of the welding tape of FIG. 1;

FIG. 2b is a plan view showing the non-adhesive side of a length of the welding tape of FIG. 1, and illustrating a visual indicator thereon that can be used for tape alignment;

FIG. 2c is a plan view showing the non-adhesive side of a length of the welding tape of FIG. 1, and illustrating an alternative visual indicator thereon that can be used for tape alignment;

FIG. 3a is a cross-sectional view of the welding tape of FIG. 1 taken along line 3-3 in FIG. 2, with a single adhesive backing sheet being disposed on the two adhesive-covered regions of the tape;

FIG. 3b is a cross-sectional view of the welding tape of FIG. 1 taken along line 3-3 in FIG. 2, with a pair of adhesive backing sheet being respectively disposed on the two adhesive-covered regions of the tape; and

FIG. 4 is a side view of the pipe junction of FIG. 1 showing the welding tape installed at a pipe junction and being partially peeled back to facilitate welding.

### DETAILED DESCRIPTION OF PREFERRED EMBODIMENTS

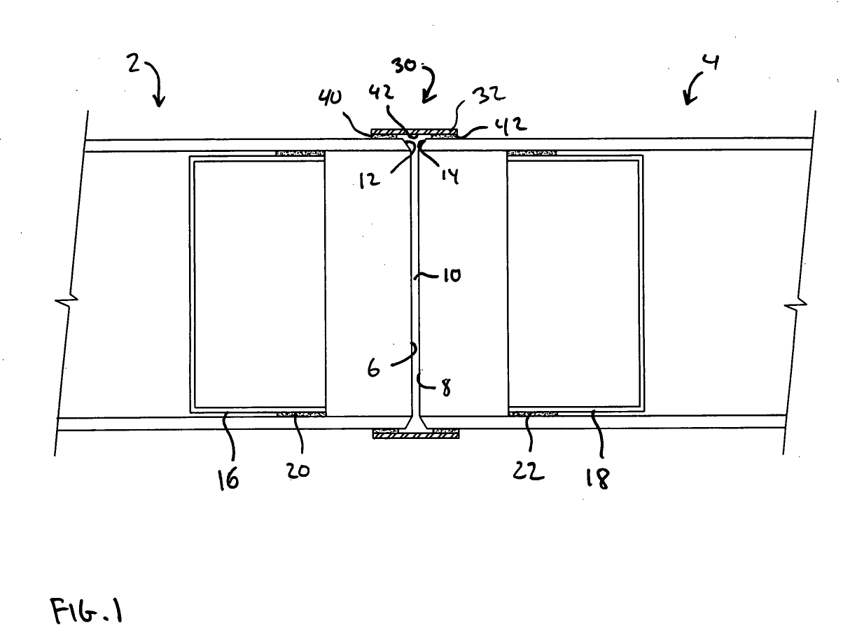

Turning now to the Drawings, which are not necessarily to scale, FIG. 1 illustrates a pair of pipes 2 and 4 that are situated so that the respective ends 6 and 8 thereof are adjacently disposed in closely spaced relationship. This placement defines a circumferential pipe junction 10 where a pipe joint is to be welded. The ends 6 and 8 of the pipes 2 and 4 are respectively chamfered at 12 and 14 in order to facilitate the formation of a conventional butt weld. It will be appreciated that the pipe ends 6 and 8 could also be non-chamfered. As indicated by way of background above, the junction 10 is formed with a small gap so that an inert gas can be introduced into the interior region of the pipes 2 and 4 using a conventional purge gas needle injector. As additionally discussed by way of background above, alternative purge gas introduction means could be used, such that a gap between the pipe ends 6 and 8 would not be required, and the pipe ends could be substantially abutting. Nonetheless, even if a gap is not intentionally maintained, the pipe junction 10 may still comprise gap openings due to surface imperfections and dimensional tolerances at the pipe ends 6 and 8.

In order to retain the injected purge gas in the vicinity of the pipe junction 10 during welding, a pair of purge dams 16 and 18 can be secured to interior end portions of the pipes 2 and 4, using adhesive-coatings 20 and 22. The purge dams are ideally made from water-soluble paper that can be dissolved subsequent to welding. Other types of barriers, such as inflatable bladders, may also be used. Although wasteful, another option would be to simply charge the entire pipeline with purge gas. To block the gap around the pipe junction 10 itself, a strip of welding tape 30 is circumferentially adhered thereto. This seals the junction 10 against the escape of purge gas from the interior of the pipes 2 and 4, and prevents the ingress of ambient air into this region.

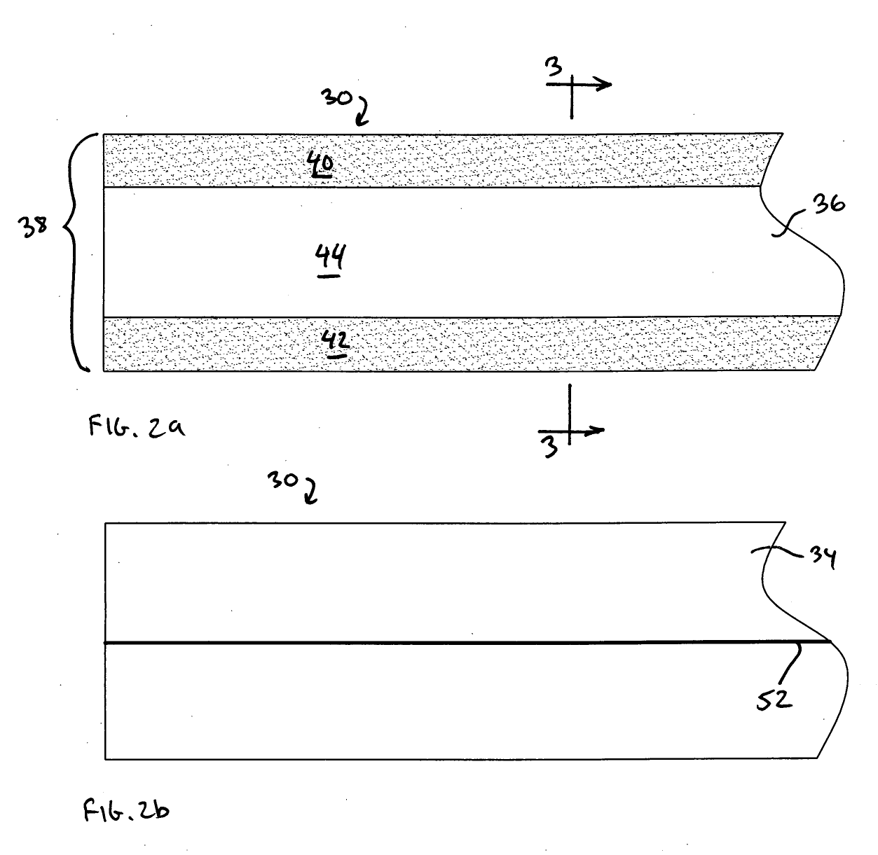

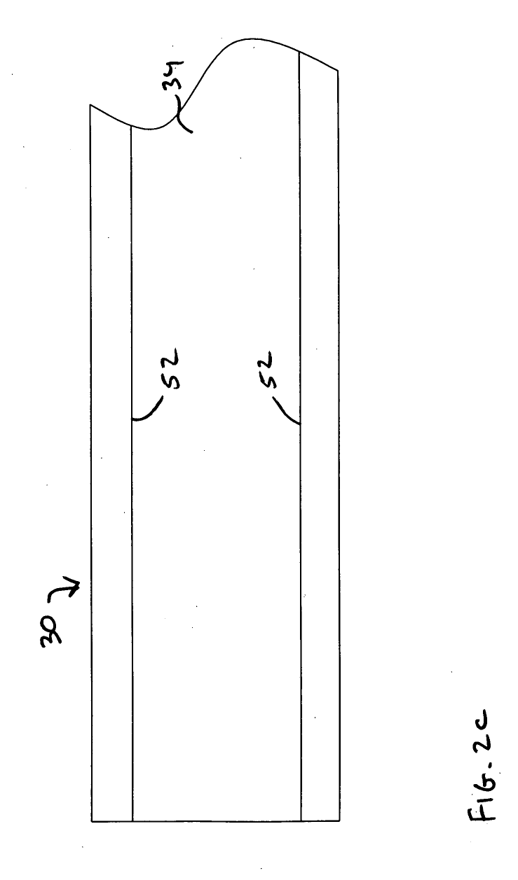

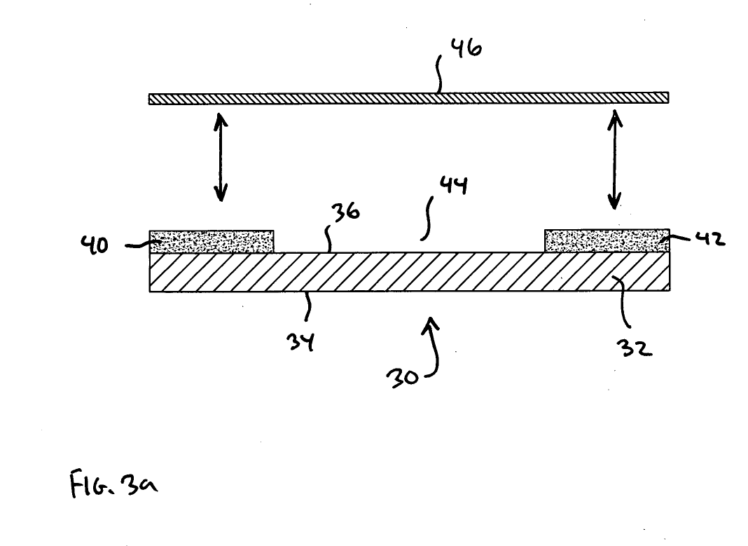

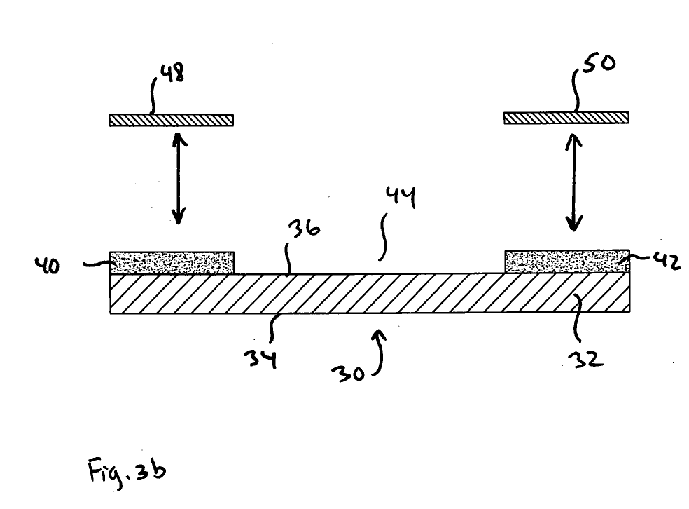

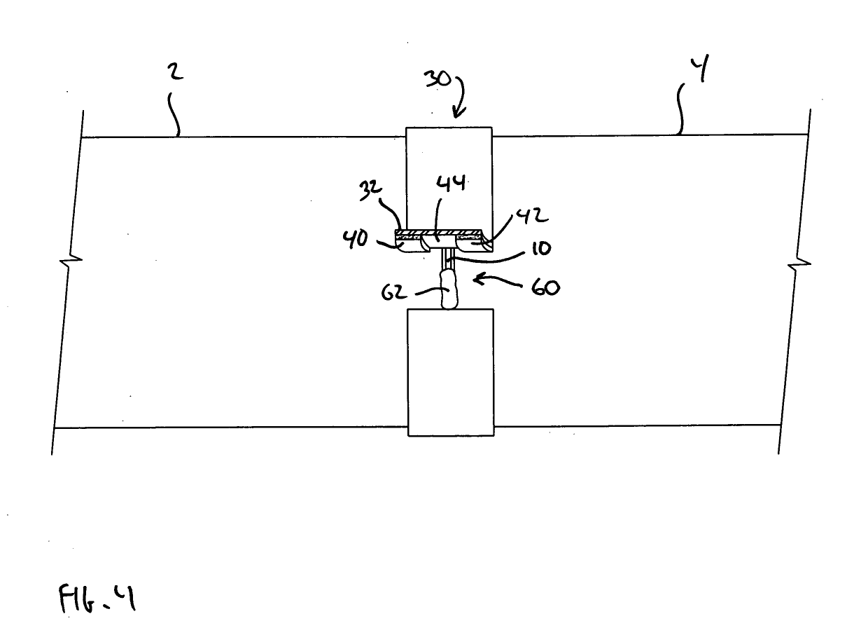

As additionally shown in FIGS. 2a, 2b, 3a and 3b, the welding tape 30 is formed by a thin flexible substrate 32 comprising steel foil, aluminum foil, or other suitable material that is preferably heat resistant. The substrate 32 has an outer side 34 adapted to face away from the pipes 2 and 4 when the welding tape 30 is adhered thereto, and an inner side 36 adapted to face toward the pipes. A pattern of adhesive 38 is formed on the inner side 36. The adhesive pattern 38 defines two lateral adhesive regions 40 and 42 that are disposed along each side of a central adhesive-free zone 44 that extends longitudinally along the length of the substrate 32. In the adhesive-free zone 44, there is substantially no adhesive and preferably no material other than the substrate 32 itself. In this way, there will be substantially no possibility of contaminants being deposited in the weld zone by the welding tape 30.

It will be appreciated that the width of the adhesive free zone 44 should be sufficient to span the weld zone of the weld to be created. For the pipes 2 and 4 of FIG. 1, the weld zone would include the junction 10 and the chamfered portions 12 and 14 of the pipes. In practice, the width of the adhesive-free zone 44 will thus be selected according to the size of the weld joint to be formed. This will likewise dictate the width of the adhesive regions 40 and 42, as well as the overall width of the substrate 32. By way of example only, for smaller welds, the welding tape 30 might be 2½ inches wide, with the adhesive-free zone 44 being 1 inch wide and the adhesive regions 40 and 42 each being ¾ inches wide. For larger welds, the welding tape 30 might be 4 inches wide, with the adhesive-free zone 44 being 2 inches wide and the adhesive regions 40 and 42 each being 1 inch wide. Many other variations would also be possible.

The adhesive regions 40 and 42 can be formed by applying a suitable adhesive material, such as a conventional halogen-free adhesive, or any other adhesive conventionally used for welding tape, to the inner side 36 of the substrate 32 using a conventional coating process. Any suitable processing technique can be used to define the geometry of the adhesive free zone 44. This would include the use of a single coating operation with a central mask placed over the area of the adhesive free zone 44 to induce adhesive coverage only in the adhesive regions 40 and 42. Alternatively, the adhesive regions 40 and 42 could be created by way of separate spatially-controlled coatings. Conventional roll coating, spray coating or other techniques may be used to apply the adhesive in either case.

As shown in FIG. 3a, a single backing sheet 46 formed from conventional adhesive backing material can be applied to cover the adhesive regions 40 and 42, and the adhesive-free zone 44. Alternatively, as shown in FIG. 3b, a pair of backing sheets 48 and 50 can be applied to respectively cover the adhesive regions 40 and 42, with all or a portion of the adhesive-free zone 44 remaining uncovered if so desired.

As shown in FIG. 2b, the outer side 34 of the substrate 32 can be optionally provided with a visual indicator 52 that corresponds to the center of the adhesive-free zone 44. This will help with placement of the welding tape 30 when taping the pipe junction 10. The indicator 52 can be configured as a line pattern formed by way of an ink or dye, or by scoring, or via any other visually apparent means. Combinations of indicating methods could also be used. The line pattern can range in thickness from a very thin centerline to a strip having substantially the same width as the adhesive-free zone 44. Alternatively, as shown in FIG. 2c, the visual indicator 52 could comprise a pair of line patterns respectively corresponding to the edges of the adhesive-free zone 44, where it meets the adhesive regions 40 and 42. Conveniently, such line patterns can be formed as a result of rolling the welding tape 30 into a tight roll following manufacture. Because of the adhesive regions 40 and 42 are generally thicker than the adhesive-free zone 44, the squeezing pressure on the welding tape 30 caused by the rolling process will tend to impart creases that correspond to the edges of the adhesive regions 40 and 42. These creases are visually apparent on the outer side 34 of the substrate 32 and thus can be used as the visual indicator 52.

As shown in FIG. 4, when taping is to be performed, a suitable length of the welding tape 30 is prepared by peeling off the removable backing sheet 46, or both backing sheets 48 and 50 (if such are present) to expose the adhesive regions 40 and 42. The welding tape 30 is then placed circumferentially around the ends of the pipes 2 and 4 so as to cover the junction 10. Note that either a single long strip or several shorter strips of the welding tape 30 could be used, depending on user preference. During the strip placement, care should be taken to insure that the welding tape 30 is centered over the junction 10, such as by observing the visual indicator 52 if it is present. This will ensure that the adhesive-free zone 44 will span the entire weld zone, including the junction 10 and the chamfered portions 12 and 14 of the pipes 2 and 4, which is where the weld will be formed. Once the desired positioning is achieved, the adhesive region 40 can be adhered to the outer edge of the pipe 2 and the adhesive region 42 can be adhered to the outer edge of the pipe 4, or visa versa. If the tape is properly positioned, neither of the adhesive regions 40 or 42 will encroach upon the weld zone, thus facilitating a contaminant-free weld.

Following installation, one or more strips of the welding tape 30 will extend substantially around the circumference of the pipes 2 and 4. A portion of the welding tape 30 can then be peeled back in order to expose a small circumferential area 60 that is ready to receive a weld 62. As welding proceeds, more of the welding tape 30 will be peeled back to expose the next area to be welded. This process will be repeated until the weld 62 is completed. Advantageously, because of the welding tape's adhesive-free zone 42, there will be no possibility of adhesive residue remaining on any pipe surface that will form part of the welded pipe joint. If any adhesive does remains on the pipes 2 and 4, it will be in the areas underlying the adhesive regions 40 and 42, which are situated laterally outside of the weld zone.

Accordingly, an improved inert gas welding tape and a related taping method have been disclosed. While various embodiments of the invention have been described, it should be apparent that many variations and alternative embodiments could be implemented in accordance with the teachings set forth herein. For example, a welding tape could be constructed with an adhesive-free zone that extends laterally across the width of the tape, with adhesive regions on either side. A repeating pattern of segments comprising such adhesive-free zones and lateral adhesive regions could then be formed longitudinally on the tape. A user would tear off as many of these segments as required to tape the area to be welded. It will therefore be understood that the invention is not to be in any way limited except in accordance with the spirit of the appended claims and their equivalents.

What is claimed is:

1. A welding tape for retaining a purge gas at a weld zone situated at a junction between two structures to be welded together, comprising:
a flexible substrate;
a pattern of adhesive on one side of said substrate; and
said adhesive pattern defining an adhesive-free zone of said welding tape that is substantially free of adhesive and of sufficient size to span said weld zone;
whereby when said welding tape is adhered to cover said junction between said structures to be welded, no adhesive will be present in said weld zone to foul a weld joint created in said weld zone.

2. A welding tape in accordance with claim 1, wherein said adhesive-free zone extends over a central longitudinal area of said substrate.

3. A welding tape in accordance with claim 1, wherein said adhesive-free zone is disposed between a pair of adhesive regions.

4. A welding tape in accordance with claim 1, wherein said adhesive pattern comprises a first adhesive region on a first lateral portion of said substrate, a second adhesive region on a second lateral portion of said substrate, and said adhesive-free zone is disposed between said first and second adhesive regions.

5. A welding tape in accordance with claim 1, further including a backing covering said adhesive pattern.

6. A welding tape in accordance with claim 1, further including plural backings respectively covering different portions of said adhesive pattern.

7. A welding tape in accordance with claim 1, further including a visual indicator on a side of said substrate that does not include said adhesive pattern for indicating the location of said adhesive-free zone.

8. A welding tape in accordance with claim 7, wherein said visual indicator comprises a line pattern indicating a central portion of said adhesive-free zone.

9. A welding tape in accordance with claim 7, wherein said visual indicator comprises a line pattern indicating edges of said adhesive-free zone.

10. A welding tape in accordance with claim 7, wherein said visual indicator comprises one or more of an ink or dye, scoring or creasing.

11. A taping method using a welding tape for retaining a purge gas around a weld zone that is situated at a junction between two structures to be welded together, comprising:
selecting a suitable length of a welding tape comprising:
a flexible substrate;
a pattern of adhesive on one side of said substrate; and
said adhesive pattern defining an adhesive-free zone of said welding tape that is substantially free of adhesive and of sufficient size to span said weld zone;
removing any adhesive backing that may be present on said welding tape;
positioning said welding tape over said junction between said structures to be welded so that no adhesive will be present in said weld zone to foul a weld joint created in said weld zone; and
adhering adhesive portions of said adhesive pattern to said structures to be welded.

12. A method in accordance with claim 11, wherein said adhesive-free zone extends over a central longitudinal area of said substrate and said welding tape is positioned so that said adhesive-free zone is substantially centered over said junction.

13. A method in accordance with claim 11, wherein said wherein said adhesive-free zone is disposed between a pair of adhesive regions and a first one of said adhesive regions is adhered to a first one of said structures and a second one of said adhesive regions is adhered to a second one of said structures.

14. A method in accordance with claim 11, wherein said adhesive pattern comprises a first adhesive region on a first lateral portion of said substrate, a second adhesive region on a second lateral portion of said substrate, and said adhesive-free zone is disposed between said first and second adhesive regions, and wherein said welding tape is positioned so that said adhesive-free zone is substantially centered over said junction and said first adhesive region is adhered to a first one of said structures and said second adhesive region is adhered to a second one of said structures.

15. A method in accordance with claim 11, wherein said welding tape comprises a single backing covering said adhesive pattern and said single backing is removed prior to taping.

16. A method in accordance with claim 1, wherein said welding tape comprises plural backings respectively covering different portions of said adhesive pattern and said plural backings are removed prior to taping.

17. A method in accordance with claim 11, wherein said welding tape comprises a visual indicator on a side of said substrate that does not include said adhesive pattern for indicating the location of said adhesive-free zone.

18. A method in accordance with claim 17, wherein said visual indicator comprises a line pattern indicating a central portion of said adhesive-free zone.

19. A method in accordance with claim 17, wherein said visual indicator comprises a line pattern indicating edges of said adhesive-free zone.

20. A method in accordance with claim 17, wherein said visual indicator comprises one or more of an ink or dye, scoring or creasing.

21. A welding tape for retaining a purge gas around a weld zone that is situated at a junction between two structures to be welded together, comprising:
a flexible substrate made from a heat-resistant material;
a pattern of halogen-free adhesive on one side of said substrate;
said adhesive pattern defining an adhesive-free zone of said welding tape that is substantially free of adhesive and of sufficient size to span said weld zone;
said adhesive-free zone extending over a central longitudinal area of said substrate that is formed between a pair of lateral adhesive regions;
said lateral adhesive regions including a first adhesive region on a first lateral portion of said substrate and a second adhesive region on a second lateral portion of said substrate;
whereby when said welding tape is adhered to cover said junction between said structures to be welded, with said adhesive-free zone being substantially centered on said junction, no adhesive will be present in said weld zone to foul a weld joint created in said weld zone.
